(19) United States
(12) Patent Application Publication
(10) Pub. No.: US 2013/0311549 A1
(43) Pub. Date: Nov. 21, 2013

(54) FRAMEWORK FOR SERVICE PERSONALIZATION

(71) Applicant: Rockstar Consortium US LP, (US)

(72) Inventors: Barbir Abdulkadev, Ottawa (CA); Nicholas C. Bennett, Ottawa (CA); Nalin N. Mistry, Nepean (CA)

(73) Assignee: Rockstar Consortium US LP, Plano, TX (US)

(21) Appl. No.: 13/872,458

(22) Filed: Apr. 29, 2013

Related U.S. Application Data
(63) Continuation of application No. 10/013,678, filed on Dec. 13, 2001, now abandoned.

(51) Int. Cl. H04L 29/08

(52) U.S. Cl. CPC H04L 67/306
USPC 709/203

(57) ABSTRACT

A framework for service personalization based upon a user's personal profile is provided. The framework includes a method of providing service personalization (SP) in which a user agent identities itself as being service personalization enabled to begin a SP session. A SP engine assigns a unique identifier to the user agent for tagging all subsequent traffic from that subscriber. The SP engine establishes direct communications between the user agent and an appropriate entity for obtaining information on the location of the subscriber profile and derives personalization rules to form a personalization rule module that encodes criteria for performing personalization functions on user traffic. When a specific subscriber request for content is received, the SP engine invokes the personalization rules of the personalization rule module for application to content requested.

### RELATED APPLICATIONS

This application is a continuation of co-pending U.S. patent application Ser. No. 10/013,678, filed on Dec. 13, 2001, entitled FRAMEWORK FOR SERVICE PERSONALIZATION, which is hereby incorporated herein by reference in its entirety.

### TECHNICAL FIELD

The present invention relates to frameworks for service personalization and is particularly concerned with personalization of content.

### BACKGROUND

In the Internet today, personalization and profiling services are typically provided to subscribers by portals. Portals require subscribers to log on to their sites, which helps to identify the subscriber. Portals also may perform subscriber profiling by tracking their habits and preferences. In order to be able to create accurate subscriber profiles, these portals must rely on co-located subscriber identification and profiling information from either participating web sites.

Consequently, current schemes for providing personalization services end up having to rely on piecemeal subscriber identification and profiling. The schemes require the subscriber to repeatedly log on to various portals or web sites, since each portal has a finite number of web sites with which it has arrangements to share subscriber information. This duplication of effort by the subscriber can be quite burdensome and may result in losing a potential subscriber's interest before the enrollment process is completed. As a further consequence, subscriber information gets duplicated in various locations across the Internet, in a number of different formats and with ranging levels of security.

Hence, a major drawback of current personalization schemes is their reliance on origin web servers to perform the personalization tasks. This requires content providers either to store and manage different content for different subscribers, or to store and manage large collection of content to choose from based on personal profiles and other criteria that must also be stored. Either approach leads to issues when scaling or optimizing are considered. These issues are attributable to personalization being done based on incomplete or inconsistent information about the subscriber. For example, the content provider may not be aware of many types of information about the subscriber, including geographic location, QoS policy, device type, and access rate that could dramatically increase the efficiency of any personalization task undertaken on their behalf.

### SUMMARY OF THE INVENTION

An object of the present invention is to provide an improved framework for service personalization.

Accordingly, the present invention provides a framework for service personalization that is based upon personal preferences of a subscriber.

According to the present invention, the goal of personalization is to enable content services on network traffic in a personalized manner. Content services can be further categorized as being in path services and out-of-path services. Examples of such services include: virus scanning, content translation, packet filtering, content adaptation, and others. What is desired is some means of allowing subscribers to specify explicitly or implicitly which services should be applied to their traffic stream, and under what circumstances.

Accordingly the present invention provides a generalized architecture for the application of these preferences to subscriber content streams.

Conveniently an embodiment of the present invention shifts responsibility for personalizing content to an intermediary device. This has many advantages over current solutions, and represents an important value add service that could be provided by network edge caching proxies or other intermediary devices. While the present embodiment of the invention allows for performing personalization of content and services at an intermediary, it does not necessarily shift responsibility to the intermediary. This is merely one possible embodiment. Other embodiments include the content source, the user agent, or a distributed system where some or all of the above devices interact to perform personalization.

### BRIEF DESCRIPTION OF THE DRAWINGS

FIG. 1 illustrates in a block diagram a service personalization system in accordance with an embodiment of the present invention;

FIG. 2 illustrates in a directional graph a service personalization sequence of operations for a personalization server session in accordance with an embodiment of the present invention; and

FIG. 3 illustrates a personalization framework used by the system of FIG. 1 and the method of FIG. 2.

### DETAILED DESCRIPTION OF THE PREFERRED EMBODIMENT

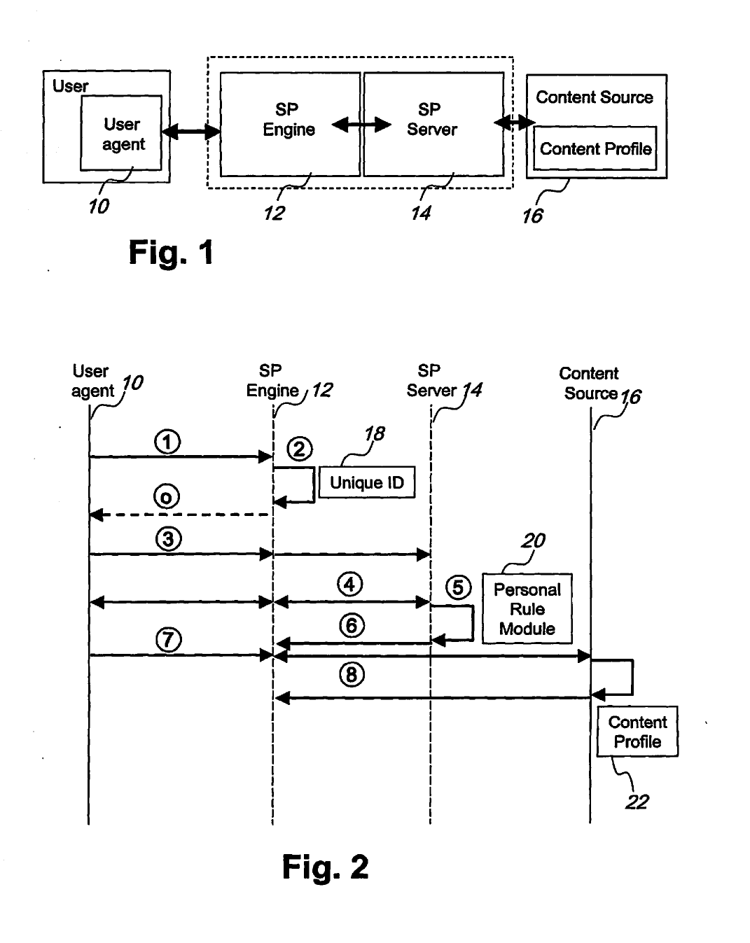

Referring to FIG. 1, there is illustrated in a functional block diagram, a service personalization system in accordance with an embodiment of the present invention. The system includes a user agent 10, a service personalization (SP) engine 12, a service personalization server 14 and a content source 16. Operation of the system is described with regard to FIG. 2.

Generally speaking, there are several scenarios involving placement of service personalization functions in the network path between the user agent 10 and the content source 16. For the present embodiments of the invention, the logical entity that performs such functions will be referred to as the SP engine 12. There are also four key factors that interrelate at some level to result in some level of service personalization. These are:
Subscriber Profile Information—Here a subscriber refers to a person whose personal preferences are being used in the interaction personalize content from content sources.
Device Information—This includes access device capabilities, machine identification, and other factors.
Network Topology/Identification Information—This can include information regarding the network path from subscriber to content
Content Profile Information—This includes content metadata and other content-related information. There are several levels of differentiated experience that can be defined in which the customization of content or content services is performed based on knowledge of information or influence in some subset of these categories. These levels can be represented in the following matrix format:

| | Subscriber | Device | Network | Content |
|---|---|---|---|---|
| Basic | X | | | |
| Moderate | X | | | X |
| Advanced | X | X | | X |
| Total | X | X | X | X |

It should be noted that not all forms of differentiated content or content services constitute personalization. Service personalization must involve differentiation of content and/or services based on user or subscriber information. That is, in order for a given form of differentiation of content or content services to be called personalized, the differentiation must be performed based at least on subscriber information.

Irrespective of which particular scenario is chosen (except for the two degenerate end-cases), the sequence of events shown in FIG. 2 must take place.

Referring to FIG. 2 there is illustrated in a directional graph a service personalization sequence of operations, for a personalization service session in accordance with an embodiment of the present invention.

The high level view presented in FIG. 1 assumes the existence of only four entities a user agent 10, a service personalization engine 12, a service personalization server 14 and a content source 16.
1. At the beginning of a session, the user agent 10 must identify itself as being SP-enabled to the SP engine 12. In effect, there must be some characteristic of a subscriber request which can be identified by the SP engine as requiring personalization services (this may be accomplished by some request header information match and associated action or by some other technique).
2. Once a SP-enabled request is identified, the SP engine 12 must assign a unique identifier 18 to the subscriber that will be used to “tag” all subsequent traffic from that subscriber. This may involve transfer of identifier information back to the user agent for incorporation into subsequent communications, as indicated by broken lines, similar to existing key-exchange mechanisms.
3. An incoming subscriber request is then routed (if necessary) to an appropriate entity an SP server 14 which may be called an SP call-out server, and which may or may not be the SP engine for processing. In the present example, for simplicity the SP engine and the SP server are shown as separate entities.
4. The SP server 14 recognizes the subscriber based on the identifier that is provided by the SP engine 12. The SP server 14 establishes direct communications using UPIF or a similar protocol with the user agent 10 to obtain information on the location of the subscriber profile. An authentication scheme between the SP server 14 and the user agent 10 may be used, the specifics of which depend upon the protocol being used. In the event that the subscriber profile is distributed across various locations on the Internet, it would be necessary for the SP server 14 to authenticate itself and any other entity that is involved in the process in order to ensure security of the profile informalities.
5. The SP server 14, then parses the subscriber's profile to either extract or derive the appropriate personalization rules to form a personalization rule module 20. This is information which encodes criteria for performing personalization functions on user traffic. At this stage, device information, either derived directly from the user agent/subscriber profile, or from a known third party (eg. device vendor) is also extracted and factored into the rule generation process. If available, there may also be some known network information that may be used in this decision making process as well.
6. The SP server 14 then sends personalization rule module 20 that is associated with this subscriber to the SP engine 12. The SP engine 12 dynamically loads and invokes the rules on subsequent traffic from the subscriber. To make this happen, subsequent traffic needs to contain an “SP-enabled” indicator since there is no notion of state maintained in the SP Engine 12 on each user agent 10 beyond any active request/response pair.
7. On a specific subscriber request for content, the SP engine 12, at a minimum, invokes the personalization rules of the personalization rule module 20 on the subscriber request. It is important to note that the personalization rules can be invoked in one of four places, in two general categories. The rules can either be invoked on the subscriber request, or on the response from the content source. Specifically, the rules can be applied: 1) When the request enters the SP engine; 2) When the request leaves the SP engine; 3) When the response from the content source enters the SP engine; and finally 4) When the response from the content source leaves the SP engine.
8. Once the content source is known from the subscriber request for content, a subsequent function which must be performed by either the SP engine 12 or the SP server 14 is to retrieve an associated content profile 22 from a content source and reconcile content profile rules with subscriber rules. FIG. 1 shows the SP engine 12 performing this task.
9. At the end of the session, the SP engine 12 informs the SP server 14 about the termination of the session. The SP server 14 invokes any accounting processing that is needed on the subscriber profile and then sends a command to the SP engine 12 to fully delete any rules that are associated with the subscriber.

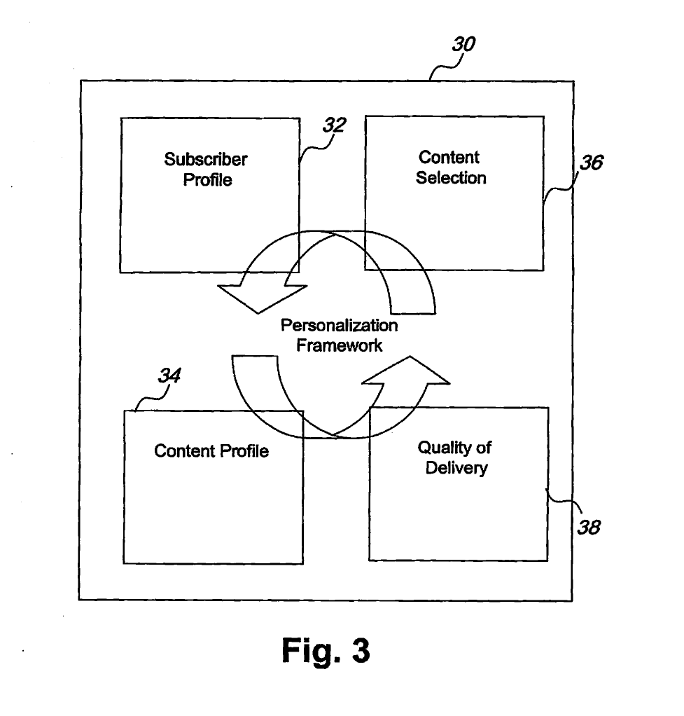

Referring to FIG. 3, there is illustrated a service personalization framework used by the service personalization system of FIG. 1. The framework 30 includes a subscriber profile 32, a content profile 34, a content selection 36, and a quality of delivery 38.

The concept of a “session” depends largely on the underlying protocols and methodologies used for communication between the content source and the user agent. For example, each session could be merely an HTTP request/response sequence; every request from the user agent and every response from the content source are “tracked”, and there are associated processing points where decisions are made about how such traffic should be personalized.

What is claimed is:

1. A method of providing service personalization comprising the steps of:
receive, by a personalization engine, a request from a client device, the request including an indication the client device is personalization enabled;
initiating a session between the client device and the personalization engine;
providing, by the personalization engine to the client device, a unique identifier;
obtaining, by the personalization engine, a personalization profile associated with the client device;
receiving, by the personalization engine, a second request from the client device, the second request directed toward a first web server and including the unique identifier;
sending the second request to the first web server;
receiving a first response to the second request from the first web server;
modifying the first response in accordance with the personalization profile;
providing the first response to the client device;
receiving, by the personalization engine, a third request from the client device, the third request directed toward a second web server and omitting the unique identifier;
sending the third request to the second web server;
receiving a second response to the second request from the second web server;
modifying the second response in accordance with the personalization profile; and
based on the omission of the unique identifier in the third request, providing the second response to the client device without modifying the second response in accordance with the personalization profile.
